(19) United States
(12) Patent Application Publication
(10) Pub. No.: US 2007/0057881 A1
(43) Pub. Date: Mar. 15, 2007

(54) Transflective display having an OLED region and an LCD region

(75) Inventors: Guo-Hua Yu, Shenzhen (CN); Yu-Hsun Jen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/518,663

(22) Filed: Sep. 11, 2006

(30) Foreign Application Priority Data
Sep. 9, 2005 (TW) 94131002

(51) Int. Cl. G09G 3/32

(52) U.S. Cl. 345/82

(57) ABSTRACT

An exemplary transflective display (100) has a first substrate (110); a second substrate (120); and a plurality of pixels defined between the first substrate and the second substrate. Each pixel has an organic light emitting diode (OLED) region and a liquid crystal display (LCD) region adjacent to the OLED region.

### BACKGROUND OF THE INVENTION

1. Field of the Invention

The present invention relates to displays, and more particularly to a transflective display having an OLED region and an LCD region.

2. General Background

Recently, LCDs that are light and thin and have low power consumption characteristics have been widely used in office automation equipment, video units and the like. Among LCD products, there have been the following three types of LCD devices commercially available: a reflection type LCD device utilizing ambient light, a transmission type LCD device utilizing backlight, and a transflective type LCD device equipped with a half mirror and a backlight.

With a reflection type LCD device, a display becomes less visible in a poorly lit environment. In contrast, a display of a transmission type LCD device appears hazy in strong ambient light (e.g., outdoor sunlight). Thus researchers sought to provide an LCD device capable of functioning in both modes so as to yield a satisfactory display in any environment. In due course, a transflective type LCD device was developed. In general, an LCD can't self emit light beams, which needs a surface light source to provide even light for a clear display. However, the surface light source is weighty, which influences an inconvenience of installing or conveyance. The question becomes serious especially for a large-screen LCD display.

Organic light emitting diodes (OLEDs) are electronic devices that emit light in response to an applied potential. FIG. 4 illustrates a typical OLED. The OLED has a substrate 10, a metallic anode layer 11, a hole-injecting layer 12, a hole-transmitting layer 13, a light emitting layer 14, an electron-transporting layer 15, an electron-injecting layer 16, and a metallic cathode layer 17, which are formed in that order from bottom to top. In operation, a potential is provided on the metallic anode layer 11 and the metallic cathode layer 17, which makes the hole-injecting layer 12 and the electron-injecting layer 16 respectively to produce a plurality of holes and electrons. The holes and the electrons recombine in the light emitting layer 14, and make the organic material of the light emitting layer 14 release the photons. Thus, a display is attained.

When the OLED 1 is provided in a poorly lit environment, a display of the OLED is good having a high contrast. However, when the OLED 1 is used in strong ambient light (e.g., outdoor sunlight), a display of the transmission OLED 1 appears hazy.

A new display which overcomes the above-mentioned disadvantages is desired. In particular, what is needed is a display having optical characteristics both in a poorly lit environment and in strong ambient light.

### SUMMARY

An exemplary transflective display has a first substrate; a second substrate; and a plurality of pixels defined between the first substrate and the second substrate. Each pixel has an organic light emitting diode (OLED) region and a liquid crystal display (LCD) region adjacent to the OLED region.

An exemplary display has a first substrate; a second substrate; and a plurality of pixels defined between the first substrate and the second substrate. Each pixel has an organic light emitting diode (OLED) region and a liquid crystal display (LCD) region adjacent to the OLED region.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a schematic view of a pixel of a transflective display according to a first embodiment of the present invention.

FIG. 2 is a schematic view of a pixel of a transflective display according to a second embodiment of the present invention.

FIG. 3 is a schematic view of a pixel of a transflective display according to a third embodiment of the present invention.

FIG. 4 is a schematic view of a conventional OLED.

### DETAILED DESCRIPTION OF PREFERRED EMBODIMENTS

Hereinafter, preferred embodiments of the present invention will be described in detail with reference to the accompanying drawings.

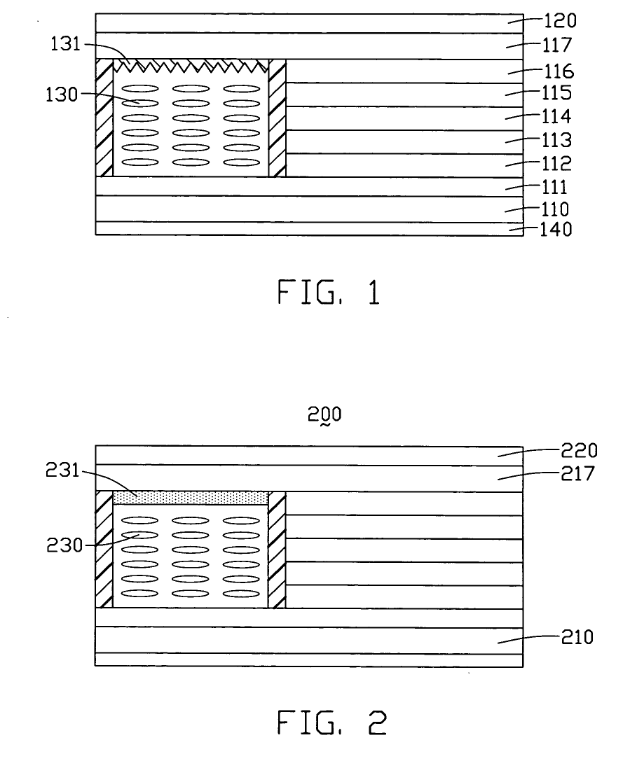

Referring to FIG. 1, a transflective display 100 according to a first embodiment of the present invention is shown. The transflective display 100 has a plurality of pixels, in each pixel, which has a first substrate 110, a second substrate 120 opposite to the first substrate 110, a first electrode layer 111 disposed in an inner surface (not labeled) of the first substrate 110, a second electrode layer 117 formed at an inner surface (not labeled) of the second substrate 120, opposite to the first electrode layer 111, a polarizer 140 adhered on an outer surface (not labeled) of the first substrate 110.

In each pixel, the transflective display 100 defines an OLED region and an LCD region adjacent to the OLED region. In the OLED region, the transflective display 100 further includes a hole-injecting layer 112, a hole-transmitting layer 113, a light emitting layer 114, an electron-transporting layer 115, and an electron-injecting layer 116, which are formed in that order from the first electrode layer 111 to the second electrode layer 117. In the LCD region, the transflective display 100 further includes a liquid crystal layer 130 disposed between the first electrode layer 111 and the second electrode layer 117. In addition, a reflective film 131 is provided between the liquid crystal layer 130 and the second electrode layer 117.

The reflective film 131 is made from a reflective material, such as silver or aluminum, which has a plurality of bumps at an inner surface (not labeled) facing the liquid crystal layer 130. The first electrode layer 111 is made of transparent material, such as indium tin oxide (ITO) or indium zinc oxide (IZO).

In operation, when the second electrode layer 112 is electrically biased to a negative potential with respect to the first electrode layer 111, holes are injected into the hole-injecting layer 112 at its interface with the first electrode layer 111 and transported across the hole-transporting layer 113 to the light emitting layer 114. Concurrently electrons are injected into the electron-injecting layer 116 at its interface with the second electrode layer 120, and the injected electrons are transported across the electron-transporting layer 117, toward the light emitting layer 114. Recombination of the holes and electrons results in electroluminescence. The light emitted can leave the OLED device in any direction. An image display can be realized. At the same time, when the potential is provided to the first and the second electrode layers 111, 112, ambient light beams from the first substrate 110 is utilized in the LCD region by the cooperaion of reflector 131 and the liquid crystal layer 130. The LCD region can realize the image display through controlling the transmittance ratio of the ambient light beams.

Therefore, when the transflective display 100 is provided in a poorly lit environment, a display of the transflective display 100 is good, having a high luminance and a high contrast by the utilization of the transmitting OLED region. When the transflective display 100 is used in strong ambient light (e.g., outdoor sunlight), a display of the transflective display 100 also has a good display characteristics by the operation of the reflective LCD region.

In addition, the transflective display 100 can attain a better display efficiency by adjusting the area ratio of the OLED region and the LCD region according to the environment in common use. In the first embodiment, the area ratio of the OLED region to a pixel can be controlled from 10% to 90%.

Referring to FIG. 2, a transflective display 200 according to a second embodiment of the present invention is shown. The transflective display 200 has a similar structure to the transflective display 100 except that a transflective film 231 replaces the reflective film 131 of the transflective display 100. The transflective film 231 is disposed between a liquid crystal layer 230 and a second electrode layer 217, which is made from a metallic film having a thickness less than 100 nm. The second electrode layer 217 is made from a transparent material. The transflective film 231 reflects the ambient light beams from a first substrate 210.

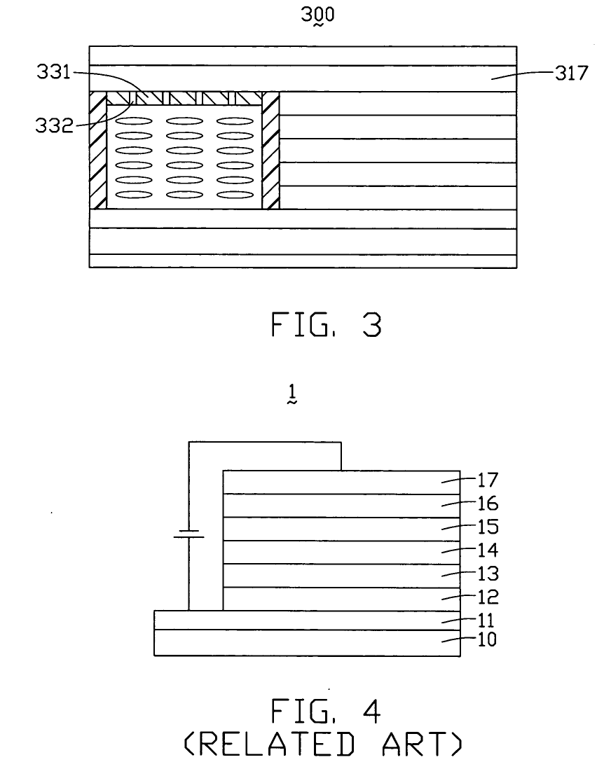

Referring to the FIG. 3, a transflective display 300 according to a third embodiment of the present invention is shown. The transflective display 300 has a similar structure to the transflective display 100 except that a reflective film 331 has a plurality micro holes 332 formed thereon. A second electrode layer 317 is made from transparent material.

When the transflective display 100, 200, 300 is provided in a poorly lit environment, a display of the transflective display 100, 200, 300 is good having a high luminance and a high contrast by the utilization of the transmittance OLED region. When the transflective display 100, 200, 300 is used in strong ambient light (e.g., outdoor sunlight), a display of the transflective display 100, 200, 300 also has a good display characteristics by the operation of the reflective LCD region.

It is to be further understood that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A transflective display, comprising:
a first substrate;
a second substrate; and
a plurality of pixels defined between the first substrate and the second substrate;
wherein each pixel comprises an organic light emitting diode (OLED) region and a liquid crystal display (LCD) region adjacent to the OLED region.

2. The transflective display of claim 1, wherein the LCD region is a reflective LCD region.

3. The transflective display of claim 1, wherein the LCD region is a transflective LCD region.

4. The transflective display of claim 1, wherein an area ratio of the LCD region to one pixel is from 10% to 90%.

5. The transflective display of claim 1, wherein an area ratio of the OLED region to one pixel is from 10% to 90%.

6. The transflective display of claim 1, further comprising a first electrode layer disposed in an inner surface of the first substrate, a second electrode layer formed at an inner surface of the second substrate, opposite to the first electrode layer.

7. The transflective display of claim 6, wherein the transflective display in the OLED region further comprises a hole-injecting layer, a hole-transmitting layer, a light emitting layer, an electron-transporting layer, and an electron-injecting layer, which are formed in that order from the first electrode layer to the second electrode layer.

8. The transflective display of claim 6, wherein the transflective display in the LCD region further comprises a liquid crystal layer formed between the first electrode layer and the second electrode layer, and a reflective film between the liquid crystal layer and the second electrode layer.

9. The transflective display of claim 8, wherein the reflective film is made from a reflective material, which has a plurality of bumps facing the liquid crystal layer.

10. The transflective display of claim 8, wherein the reflective film has a plurality of micro holes formed thereon and the second electrode layer is made from a transparent material.

11. The transflective display of claim 6, wherein the transflective display in the LCD region further comprises a liquid crystal layer formed between the first electrode layer and the second electrode layer, and a transflective film between the liquid crystal layer and the second electrode layer.

12. The transflective display of claim 6, wherein the transflective film is made from a metallic film having a thickness less than 100 nm, and the second electrode layer is made from a transparent material.

13. The transflective display of claim 6, further comprising a polarizer disposed on the first substrate.

14. A display, comprising:
a first substrate;
a second substrate; and
a plurality of pixels defined between the first substrate and the second substrate;
wherein each pixel comprises an organic light emitting diode (OLED) region and a liquid crystal display (LCD) region adjacent to the OLED region.

15. The display of claim 14, wherein the LCD region is a reflective LCD region.

16. The display of claim 14, wherein the LCD region is a transflective LCD region.
